(19) United States
(12) Patent Application Publication
(10) Pub. No.: US 2008/0121342 A1
(43) Pub. Date: May 29, 2008

(54) Manufacturing process for three-dimensional patterned leather for textile

(76) Inventor: Lung-Wen Chou, Longjing Township (TW)

Correspondence Address: BRUCE H. TROXELL, SUITE 1404, 5205 LEESBURG PIKE, FALLS CHURCH, VA, 22041, US

(21) Appl. No.: 11/605,444

(22) Filed: Nov. 29, 2006

(51) Int. Cl. B32B 37/26

(52) U.S. Cl. 156/289

(57) ABSTRACT

A manufacturing process for a three-dimensional patterned leather or textile is to employ a three-dimensional releasing paper transferred to a raw material mixing device to let its patterned surface filled with a PU resin with a certain thickness. Then, a flat releasing paper is attached on a surface of the PU resin opposite to the three-dimensional releasing paper, forming a semi-product that is further finished by a finishing device to become a three-dimensional patterned textile via combining with a base textile or a three-dimensional patterned leather by means of a finishing mold. No solvent is utilized through the whole process, achieving a purpose of environmental protection and public health.

### BACKGROUND OF THE INVENTION

1. Field of the invention

This invention relates to a manufacturing process for a decorative leather or textile, particularly to one formed in three dimensions.

2. Description of the Prior Art

Commonly, conventional decorating artificial leathers or textiles with pressure sensitive adhesive (PSA) have been gradually manufactured in less quantity, but in a great variety of patters, so as to meet the various needs of market. Usually, the surfaces of the artificial leathers or textiles with PSA are additionally coated by a solvent-based transfer printing via pattern-carved guiding rollers of a calender. But, the circumference of the guiding roller is always so big that it is expensive to have patterns carved on the surface of the guiding roller with a preset depth. In addition, suppose the pattern is to be switched, a new guiding roller with a new pattern has to be installed and corrected on the calender, not only posing a delay of manufacturing but also increasing cost. Moreover, a great deal of solvent used is to pollute environment and cause damage to human health.

### SUMMARY OF THE INVENTION

The objective of this invention is to offer a manufacturing process for a three-dimensional patterned leather or textile.

The invention is characterized by employing a three-dimensional releasing paper with a patterned surface, which is transferred to pass under a mixture-jetting nozzle of a raw material mixing device for filling with a PU resin jetted out of the mixture-jetting nozzle. A thickness adjuster is successively used to keep the PU resin flattened with a certain thickness. Then, the PU resin is attached with a flat releasing paper at its flat side opposite to its patterned surface, forming a semi-product, which is conveyed to a finishing device to remove the flat releasing paper for continuous finishing work. By means of a sticking ability of the PU resin before it is cured completely, the semi-product without the flat releasing paper can be bound with a base textile, or put in a finishing mold, formed in a certain shape and size, for filling with a plastic compound to keep the semi-product bound together with the molded plastic compound. A three-dimensional patterned leather or textile is therein obtained when the three-dimensional releasing paper is peeled off. None of solvent is added through the whole manufacturing process, giving no pollution and harmless to health. In addition, the three-dimensional patterned leather or textile can also be coated with a pressure sensitive adhesive to stick on a required spot.

### BRIEF DESCRIPTION OF DRAWINGS

This invention is better understood by referring to the accompanying drawings, wherein:

FIG. 1 is block diagram of a manufacturing process the present invention;

FIG. 2 is a flowing chart of a first preferred embodiment of a manufacturing process for a three-dimensional patterned leather or textile in the present invention;

FIG. 3 a cross-sectional view of a semi-product of the first preferred embodiment of a manufacturing process for a three-dimensional patterned leather or textile in the present invention;

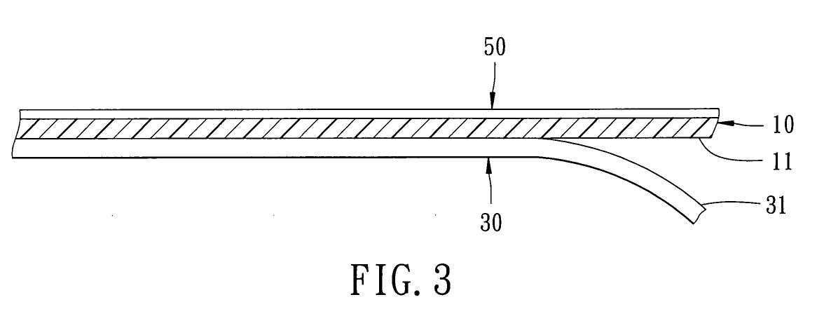

FIG. 4 a perspective view of a patterned textile of the first preferred embodiment of a manufacturing process for a three-dimensional patterned leather or textile in the present invention;

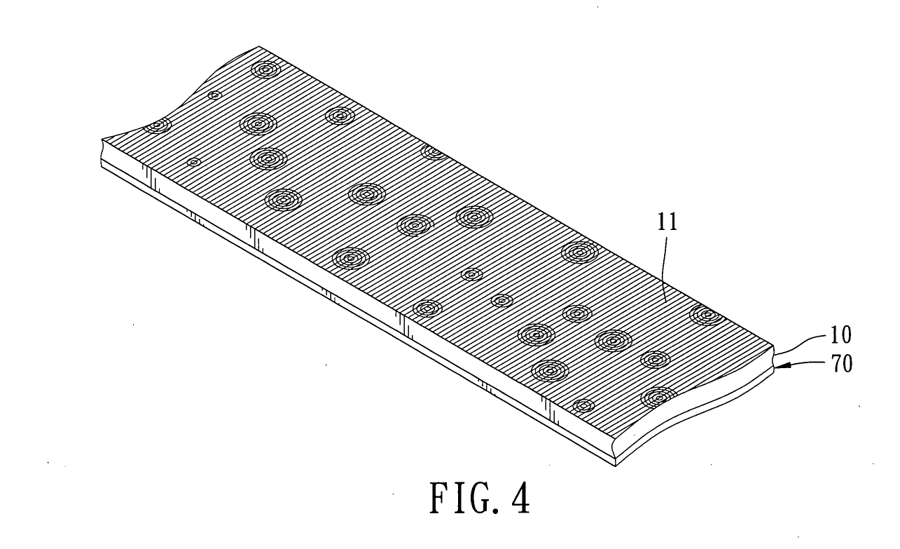

FIG. 5 is a flowing chart of a second preferred embodiment of a manufacturing process for a three-dimensional patterned leather or textile in the present invention, showing patterned leather being made;

FIG. 6 is a cross-sectional view of a finishing mold used in the second preferred embodiment of a manufacturing process for a three-dimensional patterned leather or textile in the present invention;

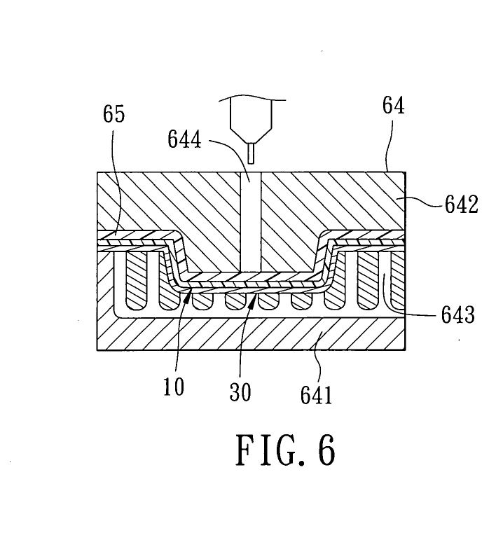

FIG. 7 is a perspective and a cross-sectional view of the patterned leather of the second preferred embodiment of a manufacturing process for a three-dimensional patterned leather or textile in the present invention, showing it being applied on a certain object; and

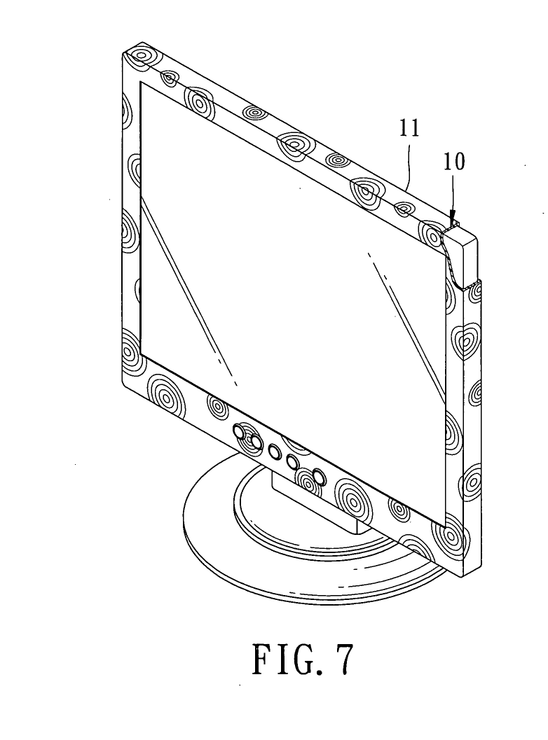

FIG. 8 is a flowing chart of a third preferred embodiment of a manufacturing process for a three-dimensional patterned leather or textile in the present invention.

### DETAILED DESCRIPTION OF THE PREFERRED EMBODIMENT

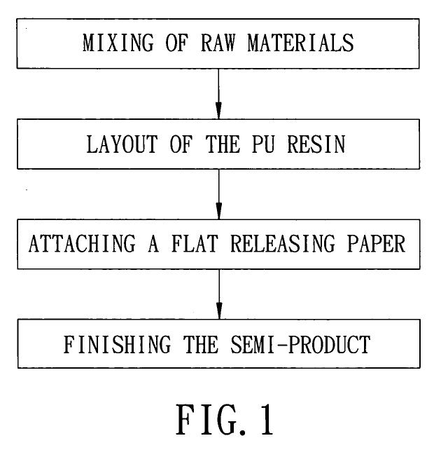

As shown in FIGS. 1˜4, a first preferred embodiment of a manufacturing process for a three-dimensional patterned leather or textile in the present invention includes the following steps:

(1) A first step of mixing of raw materials:

A PU resin 10 is composed of polyisocyanate, polyol and plural necessary pigments, which are respectively contained in various raw material tanks 21 of a raw material mixing device 20. The raw materials in the raw material tanks 21 are transferred to a longitudinal mixing tank 22 to blend homogeneously in a certain ratio in accordance with the characteristic of the PU resin 10. The PU resin 10 is then jetted out of the longitudinal mixing tank 22 through a mixture-jetting nozzle 23 set at the bottom of the longitudinal mixing tank 22. In addition, a foaming agent 24 can be added and blended in the longitudinal mixing tank 22 with a certain fraction if necessary.

(2) A second step of layout of the PU resin 10:

A roll of three-dimensional releasing paper 30 sleeved on a first roller 41 of a conveying device 40 is provided with a patterned surface 31 formed with a certain three-dimensional texture and transferred to pass under the mixture jetting nozzle 23, keeping the patterned surface 31 facing upwards to be fully filled with the PU resin 10. Then, the PU resin 10 laid out on the patterned surface 31 of the three-dimensional releasing paper 30 is flattened to obtain a certain thickness by a thickness adjuster 42 while it is conveyed by the conveying device 40 under a proper speed. The thickness adjuster 42 can be a scraper-shaped adjuster or a roller-shaped adjuster. What is used in this invention is the scraper-shaped adjuster.

(3) A third step of attaching a flat releasing paper 50:

A roll of flat releasing paper 50 is placed around a second roller 43 of the conveying device 40. The flat releasing paper 50 and the three-dimensional releasing paper 30 laid with the PU resin 10 are transferred simultaneously to contact each other just in front of two third rollers 44 and get compressed while passing through the third rollers 44. By the time, the flat releasing paper 50 and the three-dimensional releasing paper 30 are tightly attached on two sides of the PU resin 10 respectively to become a semi-product of a three-dimensional patterned leather or textile.

(4) A fourth step of finishing the semi-product: the semi-product is continuously conveyed to a finishing device 60 while the PU resin 10 has not yet hardened completely to remain sticky. First, the flat releasing paper 50 is to be taken off the semi-product 50 and rolled around a fourth roller 45. Then, according to demands, the semi-product is finished to become a three-dimensional leather or textile. In the first embodiment, the PU resin 10 without the flat releasing paper 50 and a base textile 70 placed in advance around a base textile roller 61 are conveyed to attach together just in front of two compressing rollers 62 and get compressed to bind together tightly while passing the through the compressing rollers 62, before a complete cure of the PU resin 10. Moreover, there is no solvent needed to enhance adhesion. The finished product is finally rolled around a collecting roller 63. In using, just take off the three-dimensional releasing paper 30 from the PU resin 10, so that the patterned surface 31 of the three-dimensional releasing paper 30 corresponding. to the PU resin 10 is to become a three-dimensional decorative surface 11. Thus, a three-dimensional patterned textile is obtained. In addition, the surface of the base textile 70 opposite to the PU resin 10 can be coated with a pressure sensitive adhesive so as to adhere on a surface of a certain object.

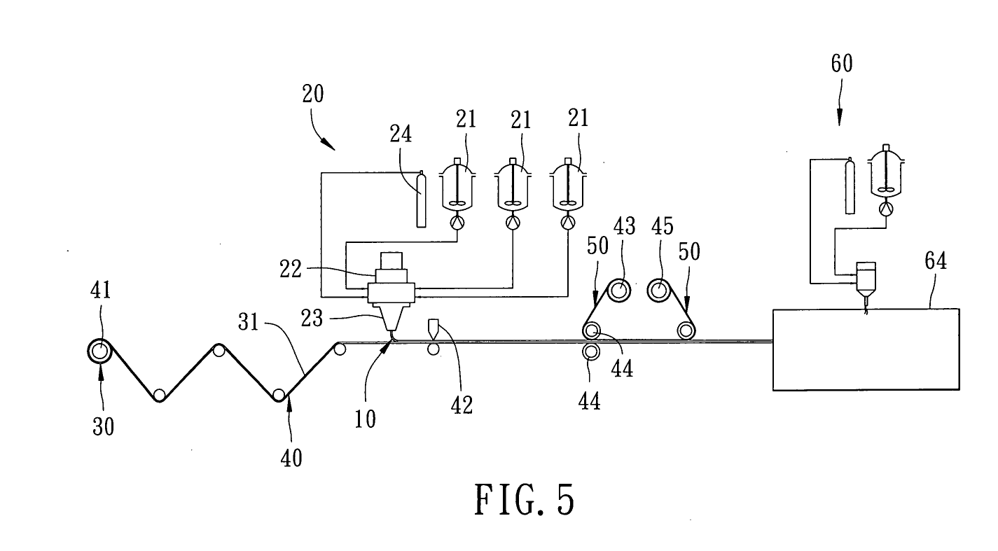

As shown in FIGS. 5˜7, a second preferred embodiment of a manufacturing process for a three-dimensional patterned leather or textile in the present invention has the same semi-product as the first embodiment does. The semi-product without the flat releasing paper 50 is transferred into a finishing mold 64 of the finishing device 60 formed in a certain shape. Next, the mold 64 is cast with a definite plastic compound 65 and molded in vacuum to keep the semi-product combined together with the plastic compound 65, enabling the PU resin 10 bound with the plastic compound 65 to form in a certain shape without adding any solvent. A three-dimensional patterned leather is therein obtained after removing the finishing mold 64. Of course, the three-dimensional patterned leather can also be coated with a pressure sensitive adhesive to adhere on a surface of a certain object. It should be further described that the finishing mold 64 is composed of a female mold 641 and a male mold 642. The female mold 641 possesses plural air vents 643 for vacuuming. The male mold 642 is provided with a casting hole 644 for injecting the plastic compound 65, which can be PP, ABS, TPU, two-component PU or two-component EPOXY.

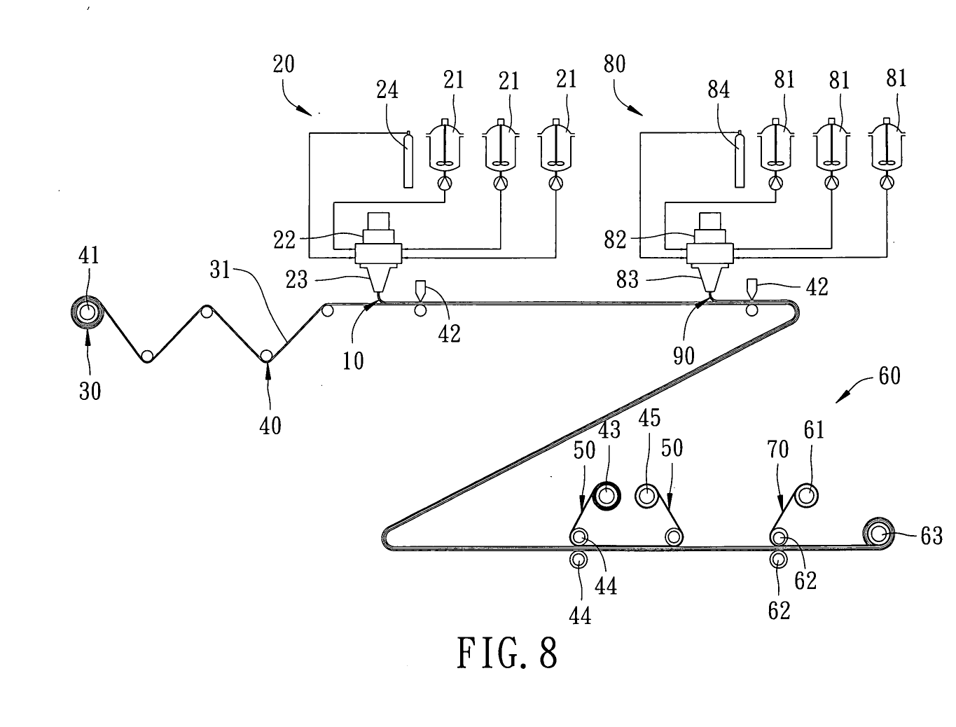

As shown in FIG. 8, a third preferred embodiment of a manufacturing process for a three-dimensional patterned leather or textile in the present invention having the same semi-product as the first embodiment does is to install another raw material mixing device 80 provided with various raw material tanks 81 for containing necessary raw materials. The raw materials in the raw material tanks 81 are transferred to a longitudinal mixing tank 82 in a certain ratio and blended together to form a homogeneous mixture, which is then jetted out of the longitudinal mixing tank 82 to form another layer of PU resin 90 covered on the PU resin 10 through a mixture jetting nozzle 83 set at the bottom of the longitudinal mixing tank 82. In addition, the PU resin 90 can also be added with a foaming agent 84.

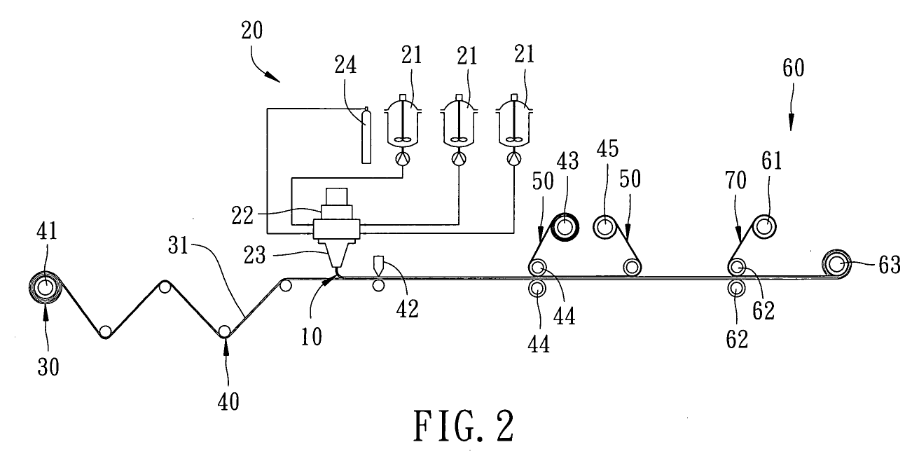

Different finishing methods can be selected to obtain the product of the invention, depending on objects to be attached, as shown in FIGS. 2˜7. Suppose the product of the invention is to be applied on clothes, bags, cushions or shoes, the semi-product can be combined with the base textile 70 to become a three-dimensional patterned textile after peeling off the three-dimensional releasing paper 30. Then, a pressure sensitive adhesive is coated on the surface of the patterned textile opposite to the decorative surface 11, for sticking on clothes, bags, cushions or shoes.

If the invention is to be applied on an object with a certain shape, such as a cover of an appliance, an automobile decorative strip, sporting goods or any handle, the semi-product can be put in the finishing mold 64 and molded together with the plastic compound 65, forming a three-dimensional patterned leather that is then coated with a pressure sensitive adhesive on the rear of the decorative surface 11 for sticking on the object targeted. Or, the object to be adhered can also be put in the finishing mold 64 to combine directly with plastic compound 65, if possible, able to save time, simplify making process and achieve effective environmental protection as no solvent is used.

FIG. 8 shows the raw material mixing devices 20 and 80 can jet out two layers of the PU resins 10 and 90 respectively, performing different properties. The PU resin 10 jetted from the raw material mixing device 20 is pigmented to have a certain color and characterized to have a good resistance to abrasion, a good anti-slipping property and a high hardness. The PU resin 90 jetted from the raw material mixing device 80 is characterized to be more flexible and coated over the PU resin 10 to obtain a three-dimensional patterned leather or textile with two layers of the PU resins 10 and 90 having different properties.

The invention has the following advantages as can be seen from the foresaid description.

1. The PU resins 10, 90 of the semi-product can be bound tightly with the base textile 70 while the PU resin is not completely cured, achieving a purpose of environmental protection because no solvent is used.

2. The three-dimensional patterned leather or textile can be used to decorate clothes, bags, shoes, covers of various appliances, an automobile decorative strip, cushions, sporting goods and all kinds of handles via different finishing work.

3. The foaming agent can help the PU resin to breathe and absorb sweat.

4. If another kind of pattern is needed, it only has to replace the three-dimensional releasing paper 30 with a new one, able to save manufacturing cost and working hours.

While the preferred embodiment of the invention has been described above, it will be recognized and understood that various modifications may be made therein and the appended claims are intended to cover all such modifications that may fall within the spirit and scope of the invention.

What is claimed is:

1. A manufacturing process for a three-dimensional patterned leather or textile, said patterned leather or textile based on polyurethane (PU) and able to decorate clothes, bags, shoes, covers of various appliances, an automobile decorative strip, cushions, sporting goods and various handles, said manufacturing process comprising:
(1) A first step of mixing of raw materials:
all necessary raw materials for said PU resin respectively contained in raw material tanks of a raw material mixing device, said raw materials in said raw material tanks transferred to a longitudinal mixing tank in a certain ratio in accordance with the characteristic of said PU resin and blended to form a homogeneous mixture of said PU resin, said mixture jetted out of said longitudinal mixing tank through a mixture jetting nozzle set at a bottom of said longitudinal mixing tank:
(2) A second step of layout of said PU resin: a roll of three-dimensional releasing paper having a patterned surface with a certain three-dimensional texture and placed around a first roller of a conveying device, said three-dimensional releasing paper keeping its patterned surface face upwards and transferred to pass through said mixture jetting nozzle to fully fill up said patterned surface with said PU resin that is flattened by a thickness adjuster while conveyed by said conveying device under a proper speed so as to obtain a certain thickness of said PU resin:
(3) A third step of attaching a flat releasing paper: a roll of flat releasing paper placed on a second roller of said conveying device, said three-dimensional releasing paper laid with said PU resin and said flat releasing paper transferred simultaneously by said conveying device to contact just in front of two third rollers and get compressed while passing through said third rollers so that said flat releasing paper and said three-dimensional releasing paper are tightly attached on two sides of said PU resin respectively to become a semi-product of a three-dimensional patterned leather or textile: and
(4) A fourth step of finishing the semi-product: said semi-product continuously conveyed to a finishing device to peel off said flat releasing paper first so as to become a semi-finished three-dimensional patterned leather or textile.

2. A manufacturing process for a three-dimensional patterned leather or textile as claimed in claim 1, wherein said semi-product without said flat releasing paper is further combined together with a base textile previously placed around a base textile roller while both of said semi-product and said base textile are simultaneously transferred to pass through two compressing rollers, forming a three-dimensional patterned textile after removing said three-dimensional releasing paper.

3. A manufacturing process for a three-dimensional patterned leather or textile as claimed in claim 1, wherein said semi-product without said flat releasing paper is conveyed to a finishing mold formed in a certain shape and size, cast with a certain plastic compound that is then molded together with said semi-product in vacuum, forming a three-dimensional patterned leather after removing said three-dimensional releasing paper.

4. A manufacturing process for a three-dimensional patterned leather or textile as claimed in claim 1, wherein said finishing mold is provided with a female mold dug with plural air vents for vacuuming and a male mold having a casting hole for injecting said plastic compound

5. A manufacturing process for a three-dimensional patterned leather or textile as claimed in claim 1, wherein said plastic compound is based on PP, ABS, TPU, two-component PU or two-component EPOXY.

6. A manufacturing process for a three-dimensional patterned leather or textile as claimed in claim 1, wherein a surface of said base textile of said three-dimensional patterned textile opposite to said PU resin is coated with a pressure sensitive adhesive for sticking on a surface of an object.

7. A. manufacturing process for a three-dimensional patterned leather or textile as claimed in claim 1, wherein a surface of said base textile of said three-dimensional patterned leather opposite to said PU resin is coated with a pressure sensitive adhesive for sticking on a surface of an object with a definite shape.

8. A manufacturing process for a three-dimensional patterned leather or textile as claimed in claim 1, wherein said PU resin is added with a foaming agent.

9. A manufacturing process for a three-dimensional patterned leather or textile as claimed in claim 1, wherein said PU resin is composed of a polyisocyanate, a polyol and plural pigments.

10. A manufacturing process for a three-dimensional patterned leather or textile as claimed in claim 1, wherein said thickness adjuster is a scraper-shaped adjuster.

11. A manufacturing process for a three-dimensional patterned leather or textile as claimed in claim 1 , wherein said thickness adjuster is a roller-shaped adjuster.

12. A manufacturing process for a three-dimensional patterned leather or textile as claimed in claim 1, wherein said PU resin laid out in said second step is re-coated with another layer of PU resin via another raw material mixing device, said two layers of PU resins having different properties.
